(19) United States
(12) Patent Application Publication
(10) Pub. No.: US 2026/0245477 A1
(43) Pub. Date: Aug. 20, 2026

(54) INSTRUMENT PERFORMANCE TRACKING SYSTEMS AND METHODS

(71) Applicant: Clebrain Co. Ltd., Daegu (KR)

(72) Inventors: Dae Geon SONG, Daejeon (KR); Jae Woo PARK, Cheonan-si (KR); Chanjung KIM, Bucheon-si (KR); Woong Chan PARK, Seoul (KR)

(73) Assignee: Clebrain Co. Ltd., Daegu (KR)

(21) Appl. No.: 18/870,902

(22) PCT Filed: May 22, 2023
(86) PCT No.: PCT/KR2023/006902

§ 371 Date: Dec. 2, 2024

(30) Foreign Application Priority Data
Jun. 3, 2022 (KR) 10-2022-0067890

(51) Int. Cl. G09B 15/02; G10G 1/02

(52) U.S. Cl. CPC G09B 15/023; G10G 1/02

(57) ABSTRACT

The present disclosure relates to a musical instrument play tracking system including at least: a device displaying a music score and creating play data for musical instrument play; and an application server including a processor, which tracks a play position on the music score, and operating a mobile application that support a musical instrument play platform. The processor includes: a landmark measure recognizer recognizing measures including the play data in the musical score as landmark measures; an important information extractor extracting important information including the play data and the frequency and length of notes in a certain measure among the landmark measures; a similarity calculator calculating similarity between the important information of the play data and the important information of the certain measure among the landmark measures; and an activator activating notes in the certain measure according to the similarity.

### TECHNICAL FIELD

The present disclosure relates to a musical instrument play tracking system and method that tracks a play position on a music score using play data obtained in real time and automatically turns the pages of a music score.

### BACKGROUND ART

Today, people not only listen to music but want to learn and play musical instruments themselves. To proficiently play musical instruments, people must undergo a process of taking lessons from an instructor or learning on their own from the basic method of producing sounds with the musical instruments to applying the method to play music scores composed of complex notes.

However, taking lessons from an instructor requires setting a side regular time for lessons and paying expensive tuition fees. Learning to play a musical instrument on one's own poses challenges, as one may not know what to practice first and find it difficult to accurately assess their skill levels, so there is a problem that this often leads to frustration or feelings of limitation in improvement of their abilities when faced with practice tasks that exceed their current abilities

Recently, electronic musical instruments that digitalize analog sound produced by basic musical instruments without any electronic device or output pre-stored digital sound source data on the basis of the finger positions of players such as a digital piano, and technologies for analyzing the playing skills of players or tracking their playing positions through play data of virtual musical instruments that output pre-stored digital sound data in accordance with input by players in a virtual graphic have been under research.

In this regard, Related Document 1 relates to a device and method for providing a customized training program based on play pattern analysis, which can analyze the play patterns of musical instrument players through sound wave analysis. Related Document 2 describes a computer-based system for music play training, which can help students learn playing techniques of musical instruments by analyzing test data of the students generated by an input device on the basis of reference data in a processor device and providing appropriate responses to the students. However, Related Documents 1 and 2 are focused on the player's education, so they have a problem of not being able to provide services that can locate the real-time position on music scores of the music that a player wants to practice or that cannot assist in actual play.

### DETAILED DESCRIPTION

### Technical Problem

In order to solve the problems described above and an objective of the present disclosure is to achieve a musical instrument play tracking system and method that obtains play data from a device, recognizes multiple measures containing the play data as landmark measures, extracts important information of the play data and a certain measure among the landmark measures, calculates similarity by comparing the important information, and activates a note on a display on the basis of the similarity.

Further, an objective of the present disclosure is to provide a musical instrument play tracking system and method that solves the problem of turning pages of a music score while a player is playing a musical instrument and that turns the pages of a music score displayed on a display in accordance with the position of a note activated by an activator in landmark measures to improve convenience of the player.

The technical subjects to implement in the present disclosure are not limited to the technical problems described above and other technical subjects that are not stated herein will be clearly understood by those skilled in the art from the following specifications.

### Technical Solution

In order to achieve the objectives, a musical instrument play tracking system provides: a device displaying a music score of music, which a player wants to play with a musical instrument, on a display and creating play data for musical instrument play of the player; and an application server including at least one processor, which tracks a play position on the music score on the basis of the play data, and operating a mobile application that support a musical instrument play platform.

The at least one processor of the present disclosure is characterized by providing: a landmark measure recognizer recognizing multiple measures including the play data in he musical score displayed on the display as landmark measures; an important information extractor extracting important information including the play data and the frequency and length of notes in a certain measure among the landmark measures; a similarity calculator calculating similarity between the important information of the play data and the important information of the certain measure among the landmark measures; and an activator activating the certain measure on the display in accordance with the similarity such that the play position is easily and visually located.

In order to achieve the objectives, a musical instrument play tracking method provides: a landmark measure recognition step in which multiple measures including play data created by a device in a music score displayed on a display of the device are recognized as landmark measures by means of a landmark measure recognizer; an important information extraction step in which important information including the play data and the frequency and length of notes in a certain measure among the landmark measures is extracted by an important information extractor; a similarity calculation step in which similarity between the important information of the play data and the landmark measures is calculated by a similarity calculator; and an activation step in which the certain measure is activated on the display in accordance with the similarity such that a play position is easily and visually located.

### Advantageous Effect

As described above, according to the present disclosure, there is an effect that a player can accurately track the current play position on a music score when playing by obtaining play data from a device, recognizing multiple measures including the play data as landmark measures, extracting important information of the play information and a certain measure among the landmark measures, calculating similarity by comparing the important information, and activating a note on the display in accordance with the similarity.

Further, the present disclosure turns a page of a music score displayed on the display in accordance with the position of a note activated in the landmark measures by the activator, whereby there is an effect of solving the problem that a player has to turn the pages of a music score while playing a musical instrument and of improving convenience for a player. Further, the present disclosure performs calculation of similarity for measures that are basic units generally for a player to recognize a music sore and performs activation on a measure-by-measure basis, whereby the current play position is not activated only on a note-wise base, as in the related art, and can be activated on a measure-wise base. Accordingly, compared to being activated only on a note-wise basis on the display, screen changes are significantly reduced, so there is an effect of allowing the current play position to be intuitively and accurately recognized without confusing a player. Further, even if the speed of activation based on measures is slightly low or high in comparison to note-wise activation on the display, there is an effect of not greatly confusing a player.

Further, the current play position of a player can be recognized only when the player start playing from the very beginning of a music score in the related art. However, according to the present disclosure, since the similarity of all of the measures in a music score displayed on the display is calculated, even though a player plays any measured in the music score displayed on the display without playing in advance from the very beginning of the music score or the measure two to three measures earlier from the measure that the player wants to play, it is possible to track the current position, whereby there is an effect that the convenience for play of a player is improved.

The effects of the present disclosure are not limited to those described above and other effects not stated herein may be made apparent to those skilled in the art from the detailed description and the claims.

### BRIEF DESCRIPTION OF DRAWINGS

FIG. 1 is a configuration diagram of a musical instrument play tracking system of the present disclosure.

FIG. 2 is a diagram showing a landmark measure and activated note and measure in accordance with an embodiment of the present disclosure.

FIG. 3 is a diagram showing sequence matching according to an embodiment of the present disclosure.

FIG. 4 is a diagram showing a Euclidean distance calculation method (a) and a dynamic time warping (DTW) technique (b) between two sequences according to an embodiment of the present disclosure.

FIG. 5 is a diagram showing similarity calculated from important information about play data and important information (b) about a certain measure among landmark measures.

FIG. 6 is a diagram showing the states before (a) and after (b) turning a page of a music score is turned on a display in accordance with an embodiment of the present disclosure.

FIG. 7 is a diagram showing measures activated over time in accordance with an embodiment of the present disclosure.

FIG. 8 is a flowchart of a musical instrument play tracking method of the present disclosure.

### MODE FOR INVENTION

Terminologies used herein were selected as terminologies that are currently used as generally as possible in consideration of the functions herein, but may be changed, depending on the intention of those skilled in the art, precedents, or advent of a new technology. Further, there are terminologies selected by applicant(s) at the applicant(s)' opinion in specific cases, and in these cases, the meanings will be described in the corresponding parts. Accordingly, the terminologies used herein should be defined on the basis of the meanings of the terminologies and the entire specification, not simply the names of the terminologies.

Unless defined otherwise, it is to be understood that all the terms used in the specification including technical and scientific terms have the same meanings as those that are understood by those who skilled in the art. It will be further understood that terms defined in dictionaries that are commonly used should be interpreted as having meanings that are consistent with their meanings in the context of the relevant art and will not be interpreted in an idealized or overly formal sense unless expressly so defined herein.

### Musical Instrument Play Tracking System

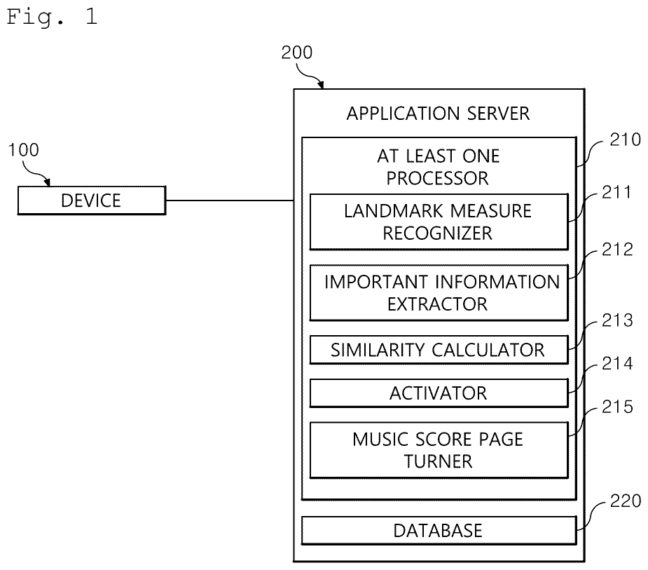

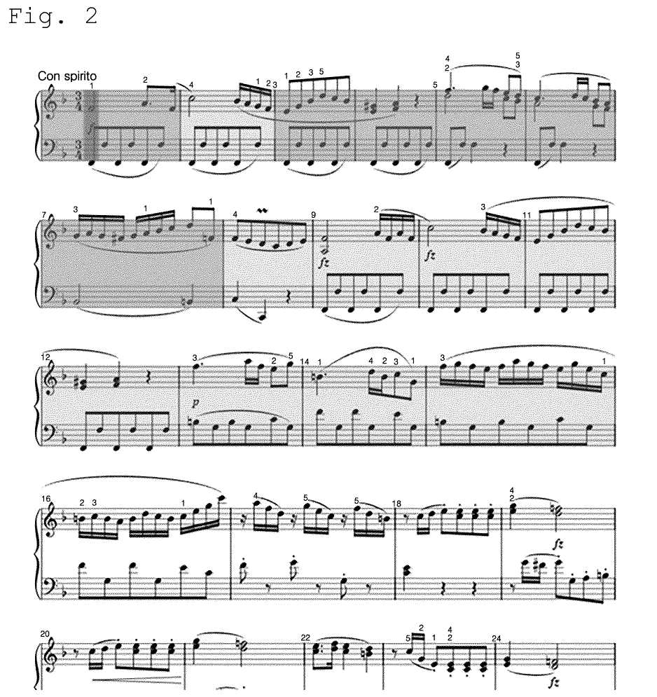

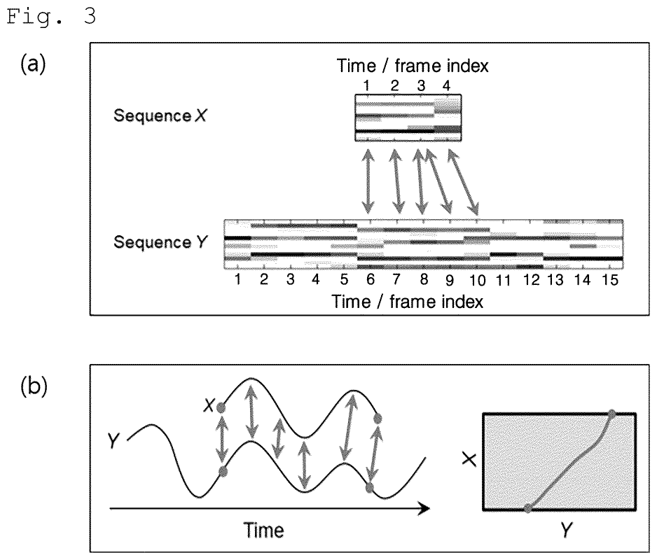

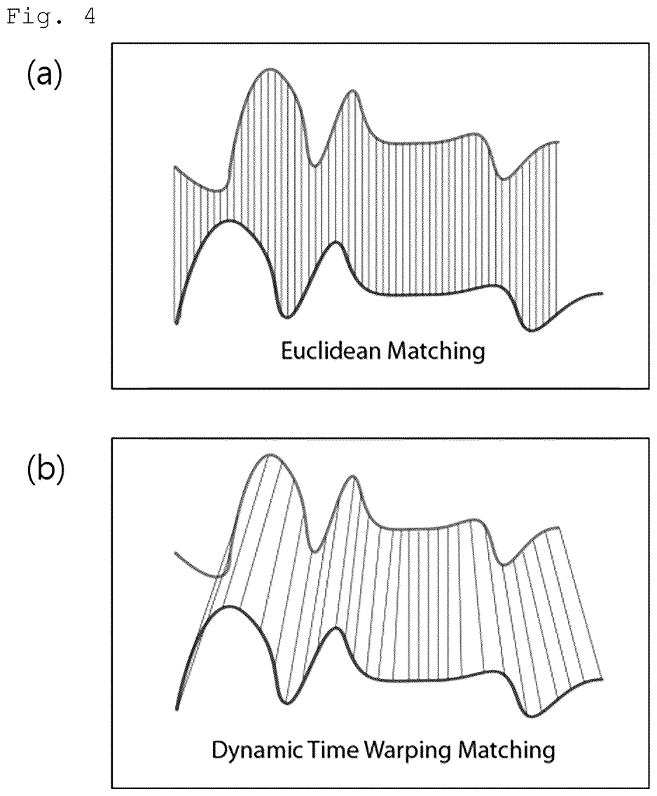

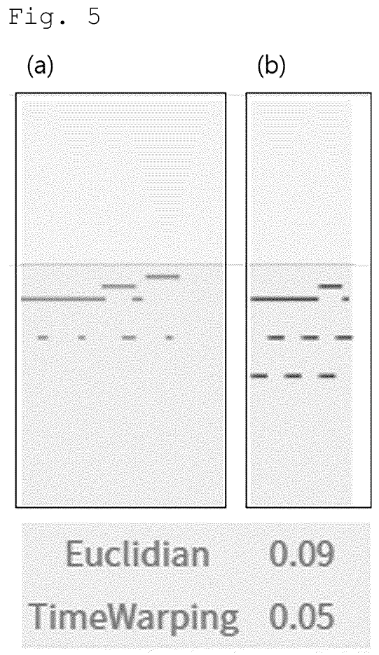

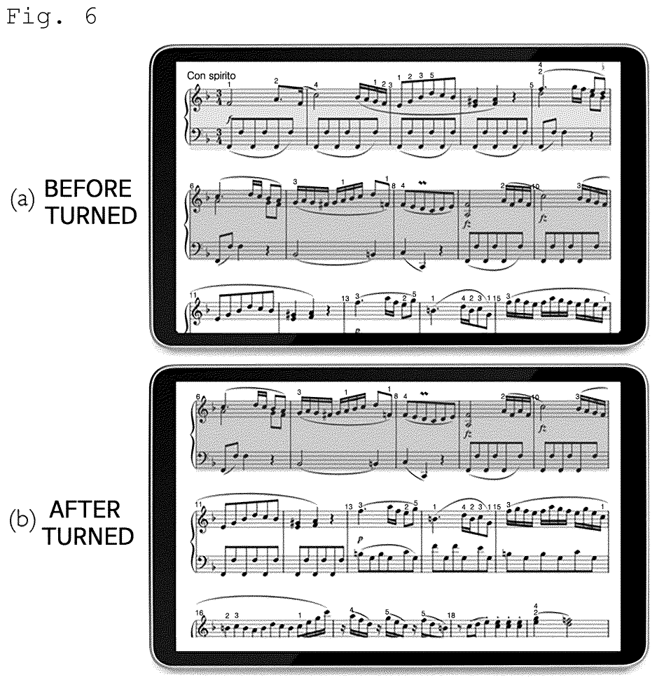

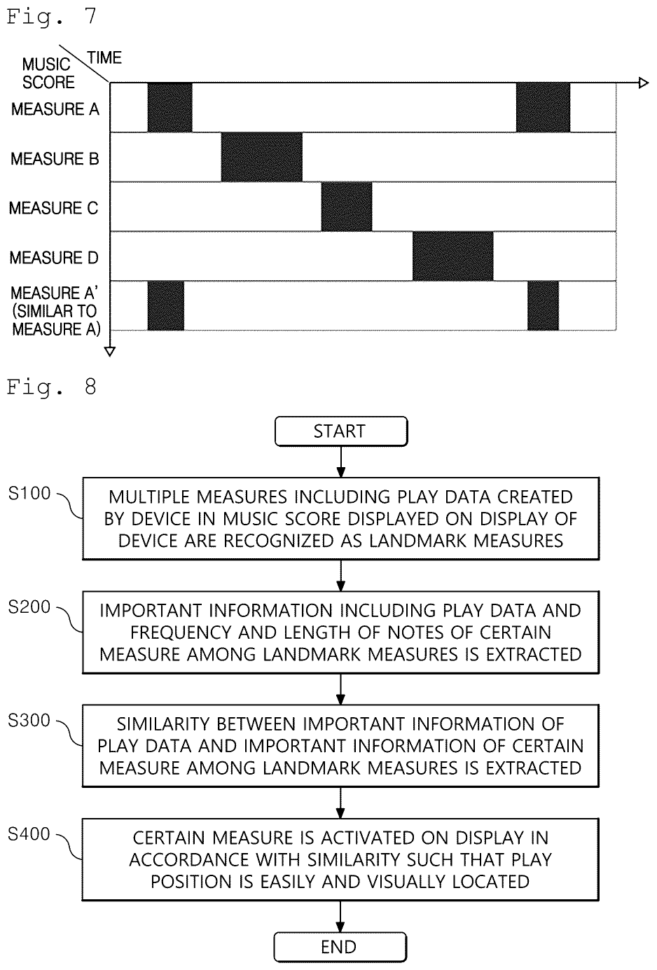

Hereafter, an embodiment of the present disclosure is described in detail with reference to the accompanying drawings. FIG. 1 is a configuration diagram of a musical instrument play tracking system of the present disclosure. FIG. 2 is a diagram showing a landmark measure and activated note and measure in accordance with an embodiment of the present disclosure. FIG. 3 is a diagram showing sequence matching according to an embodiment of the present disclosure. FIG. 4 is a diagram showing a Euclidean distance calculation method (a) and a dynamic time warping (DTW) technique (b) between two sequences according to an embodiment of the present disclosure. FIG. 5 is a diagram showing similarity calculated from important information about play data and important information (b) about a certain measure among landmark measures. FIG. 6 is a diagram showing the states before (a) and after (b) turning a page of a music score is turned on a display in accordance with an embodiment of the present disclosure. FIG. 7 is a diagram showing measures activated over time in accordance with an embodiment of the present disclosure.

First, referring to FIG. 1, a musical instrument play tracking system of the present disclosure includes; a device that shows a music score of music that a player wants to play with a musical instrument on a display 110 and creates play data about play of the musical instrument by the player; and an application server 200 that includes at least one processor tracking a play position on the music score on the basis of the play data and operating a mobile application supporting a musical instrument play platform.

In other words, the device 100 enables installation of the mobile application on the internet because it has an embedded operating system, can communicate with at least one of the application server 200 and a musical instrument through a wired or wireless communication, can receive input by a player through a touch and input unit, and may include a display 110 having a predetermined size to easily and sufficiently display the music score of music that a player wants to play. For example, it may be a smartphone, a tablet PC, a personal desktop, a laptop, a touch pad, etc.

Here, the musical instrument may be a musical instrument that produces analog sounds in accordance with the fingering of a player without any electronic device such as a grand piano, an acoustic guitar, etc. Accordingly, the device 100 receives sound through a given microphone 120 and digitalizes the sound through a frequency band conversion technology or an automatic music transcription technology, thereby being able to create the play data. Here, the automatic music transcription technology refers to arranging the notes and the length of notes of analog sounds into a bar format in order of time.

Alternatively, the musical instrument may be an electric musical instrument that outputs pre-stored digital sound sources in accordance with the finger positions of a player such as a digital piano and an electric guitar, and a musical instrument that outputs pre-stored digital sound sources in accordingly with touch input by a player on a virtual graphic having the shapes of a piano, a guitar, a drum, etc. Accordingly, the device 100 can be connected with an instrument in a wired type through a USB terminal and can receive MIDI signals, and the MIDI signals may be the play data. Alternatively, the play data may be formed by processing some of MIDI signals. Here, the MIDI signal is a standardized signaling protocol system that can be exchanged between digital musical instruments and computers or between a digital musical instrument and a digital musical instrument.

The application server 200 can transmit and receive data related to the service that a player wants to be provided with by performing communication with the mobile application installed in the device 100. For example, when a processing method of data and a UI/UX user interface are changed to improve the quality of services in the mobile application, the application server 200 can directly or indirectly access the embedded operating system on the internet such that the changes in the mobile application are reflected to the device 100 for each player.

Further, the application server 200 can process play data that is created by the device 100 and can provide various services through the processed play data through the at least one processor 210. In more detail, the at least one processor 210 includes a landmark measure recognizer 211, an important information extractor 212, a similarity calculator 213, and an activator 214.

First, the Landmark Measure Recognizer 211 Recognizes multiple measures, which include the play data in the music score displayed on the display 110, as landmark measures.

In order to play certain music, a music score written on multiple pages is required. In general, a music score is composed in accordance with a notation method including note symbols, notes, and auxiliary notations showing playing instructions and the amount of music score that can be printed on one page is limited. In the same way, the display 110 can display only a portion of the entire music score, depending on the size of the display 110 and the notation method of the music score. For example, the display 110 can display only two to four staffs of a music score even if the ratio of the displayed score is appropriately adjusted for each player.

In other words, the landmark measures may include several staffs including multiple measures, as in FIG. 2. Here, the measure refers to the part between vertical lines in a music score and is the smallest unit of music.

In this case, it is the most preferable that the landmark measure recognizer 211 determines that the play data is in the musical score displayed on the display 110. According to the embodiment of the present disclosure of FIG. 2, the landmark measure recognizer 211 can recognize up to three staffs from the top staff of a music score displayed on the display 110 as the landmark measures. The landmark measures are shown in green with a certain level of transparency on the music score in FIG. 2. When the play data is not displayed on the display 110, the device 100 can make the play data be displayed on the display 110 through an input manner such as scrolling and touching by a player.

Accordingly, when the play position of a player on the entire music score that the player is playing is tracked, the data processing time and capacity are significantly consumed. The present disclosure can reduce the target for tracking the play position of a player into the landmark measures on the entire music score using the situation in which a player has to look at a musical score to play a musical instrument, and accordingly, has a remarkable effect of being able to reduce the data processing time and capacity.

Next, the important information extractor 212 extracts important information including the play data and the frequency and length of notes in a certain measure among landmark measures.

The important information extractor 212 can separately extract the important information of the play data and the important information of the certain measure and the manners of extracting the important information are the same. Most preferably, the important information extractor 212 can convert the play data and a certain measure among the landmark measures each into a sequence represented by the pitches of notes over time. Further, the important information extractor 212 can extract the frequency of notes, the length of notes, the notes, etc. as the important information from the sequences represented by the pitches of notes over time.

Next, the similarity calculator 213 calculates similarity for the important data of the play data and a certain measure among the landmark measures. Most preferably, the similarity calculator 213 can calculate the similarity by performing subsequence matching and Dynamic Time Warping (DTW).

First, the similarity calculator 213 compares important information using a subsequence matching technique, thereby being able to infer the part corresponding to the play data in the landmark measures.

Referring to FIG. 3(a), the subsequence matching technique is an algorithm that is useful for finding a part where one certain sequence corresponds to another sequence. It is preferable for the similarity calculator 213 to use a SPRING algorithm that performs subsequence matching at a very high speed because time complexity is low.

In more detail, referring to FIG. 3(b), a sequence X may include the important information of the play data and a sequence Y may include the important information of the certain measure. In this case, the start point and the end point of each of the sequence X including the important information of the play data and the sequence Y including the important information of the certain measure have been identified. The similarity calculator 213 performs comparison using the subsequence matching technique, thereby being able to check whether there is the same part in relation to whether the important information of the play data has the same part in the important information of the certain measure, and locate the same part, or being able to check whether there is a similar part in relation to whether there is a similar part, and locate the similar part even though they are not completely the same. As a result, in the sequence Y, the part that is the same as or similar to the sequence X may be referred to as a subsequence Y′.

Next, the similarity calculator 213 computes the Euclidean distance between histograms showing the frequency of notes in the important information of each of the sequence X and the subsequence Y′ derived by the subsequence matching technique, thereby being able to calculate the similarity of the frequency of the notes.

For example, when the histogram values for the frequency of notes of the sequence X derived using the subsequence matching technique are [0.1, 0.2, 0.3, 0.2, 0.2] and the histogram values for the frequency of notes of the subsequence Y′ are [0.6, 0.1, 0.1, 0.1, 0.1], the similarity calculator 213 can derive 0.57, which is a value obtained by calculating (0.6-0.1)²+(0.1 -0.2)²+(0.1 -0.3)²+(0.1 -0.2)²+(0.1 -0.2)² in accordance with a Euclidean distance computation method and then taking the square root, as the similarity for the frequency of the notes. In this case, when the Euclidean distance is 0, it can be determined that the frequencies of notes between the sequence X and the subsequence Y′ are the same, and the closer the Euclidean distance is to 0, the higher the similarity for the frequencies of the notes between the sequence X and the subsequence Y′ can be determined.

However, referring to FIG. 4(a), since the Euclidean distance computation method performs simple comparison on the basis of time, it can calculate high similarity for perfectly matched play, but has a technical imitation in calculating low similarity for structural play errors or improvisation by a player. The present disclosure aims to overcome the aforementioned technical limitations of the Euclidean distance computation method and to allow a corresponding part of a music score to be properly activated by flexibly handling structural play errors and improvisation by a player.

Next, the similarity calculator 213 can calculate the similarity of the lengths of notes between the sequence X and the subsequence Y′ derived by the subsequence matching technique using the dynamic time warping (DTW) technique.

Referring to FIG. 4(b), the dynamic time warping (DTW) method does not simply compare two sequences and performs time-warping that randomly elongates or reduces a portion of a sequence, thereby being able to find an optimal path that makes two sequences appear as similar as possible. In this case, the dynamic time warping (DTW) has to calculate all computations on a Cost-Matrix to find an optimal path, so it becomes slower as the lengths of two sequences increase. Accordingly, the similarity calculator 213 has only to find an optimal path by performing only operations on a Cost-Matrix that corresponds to the sequence X and the subsequence Y′, so the amount of operations is low, whereby it is possible to calculate the similarity of the lengths of notes at a high operation speed.

Accordingly, in the embodiment of FIG. 5, the similarity calculator 213 can calculate the similarity of the frequencies of notes as 0.09 through a Euclidean distance measurement method and can calculate the similarity of the lengths of the notes as 0.05 through dynamic time warping (DTW). Further, the similarity calculator 213 can derive 0.14 that is the sum of the two calculated similarities as the final similarity. In this case, the smaller the similarity value, the more similar they can be determined to be.

Accordingly, the current play position of a player can be recognized only when the player start playing from the very beginning of a music score in the related art. However, according to the present disclosure, since the similarity of all of the measures in a music score displayed on the display 110, that is, the landmark measures is calculated, even though a player plays any measured in the music score displayed on the display 110 without playing in advance from the very beginning of the music score or the measure two to three measures earlier from the measure that the player wants to play, it is possible to track the current position, whereby there is an effect that the convenience for play of a player is improved.

Next, the activator 214 activates the certain measure on the display 110 in accordance with the similarity so that the play position can be visually easily located.

Most preferably, the activator 214 compares a similarity reference value obtained from a pre-trained Support Vector Machine (SVM) model and the final similarity, and can determine that the play data corresponds to a certain measure among landmark measures when the final similarity is the reference value or lower.

Meanwhile, the SVM model can be trained with positive data determined to be measures played by an unspecified majority and negative data determined to be measures not played.

For example, when the reference value obtained from the SVM model is 0.33 and the final similarity is 0.14, 0.14 that is the final similarity is smaller than the reference value, so the activator 214 can determine that a sequence X that is the play data is similar to a sequence Y′ that is a certain measure among the landmark measures and can determine that the player played the certain measure among the landmark measures. Further, the activator 214 can activate a corresponding measure and at least one of the notes included in the measure on the display 110.

On the contrary, when the reference value obtained from the SVM model is 0.33 and the final similarity is 0.36, 0.36 that is the final similarity is larger than 0.33 that is the reference value, so the activator 214 can determine that a sequence X that is the play data would not be similar to a sequence Y′ that is a certain measure among the landmark measures and may not activate the corresponding note or measure on the display 110.

Referring to FIG. 2 again, it can be seen that a note and measures activated by the activator 214 are shown in dark green in the landmark measures. Accordingly, the present disclosure performs calculation of similarity for measures that are basic units generally for a player to recognize a music sore and performs activation on a measure-by-measure basis, whereby the current play position is not activated only on a note-wise base, as in the related art, and can be activated on a measure-wise base. Accordingly, compared to being activated only on a note-wise basis on the display 110, screen changes are significantly reduced, so there is an effect of allowing the current play position to be intuitively and accurately recognized without confusing a player. Further, even if the speed of activation based on measures is slightly low or high in comparison to note-wise activation on the display 110, there is an effect of not greatly confusing a player.

Further, a player can visually check his/her current play position on a music score displayed on the display and the pages of the music score can be automatically turned solely through playing without making any gestures during playing, so there is an effect that the player can concentrate more on playing.

Next, the application server 200 further includes a database 220 storing a certain measure activated through the activator 214 and at least one of the notes included in the certain measure and the similarity calculator 213 is characterized by excluding the certain measure and at least one of the notes included in the certain measure stored in the database 220 from the selection targets to prevent them from being repeatedly activated by the activator 214.

In other words, the at least one processor 210 can repeat the processes described above to continuously activates the notes and the measures that a player is currently playing. The repeat interval may be different, depending on the interval set in advance in the at least one processor 210. For example, when 0.4 seconds is set as a repeat time, the at least one processor 210 can operate at least one of the landmark measure recognizer 211, the important information extractor 212, the similarity calculator 213, and the activator 214 repeatedly in the order of 0 seconds, 0.4 seconds, 0.8 seconds . . . .

For example, the activator 214 may activate a note A and a note B in the landmark measures at 0 seconds and 0.4 seconds, respectively. Further, the similarity calculator 213, at 0.8 seconds, can check the pre-stored note A and the note B from the database 220, and then exclude them from the similarity selection targets and calculate similarity. That is, the similarity calculator 213 can exclude the important information of the note A and the note B when calculating similarity. If the note A and the note B form a certain measure together, the database 220 can store them on a measure-by-measure basis.

Accordingly, it is possible to prevent notes and measures, which a player has already played, it is possible to improve accuracy, and it is possible to reduce the targets that need to be computed by the similarity calculator 213, so there is a remarkable effect of being able to increase the computation speed and decrease the computational load.

Next, the at least one processor 210 of the present disclosure may further include an music score page turner 215 that turns pages of a music score that are displayed on the display 110 in accordance with the positions of measures activated by the activator 214 in the landmark measures to improve convenience for a player.

As described above, a music score page displayed on the display 110 may be a portion of the entire music score of music. According to an embodiment of the present disclosure, since two to four staffs of the music score are displayed on the display 110, a situation occurs where a player needs to turn the pages of the music score while playing. The music score page turner 215 of the present disclosure aims to automatically turn the pages of a music score so that playing is not interrupted in the situation where a player needs to turn a page of the music score while playing.

An embodiment is described with reference to FIG. 6, in which landmark measures are shown in blue and green on a certain music score. That is, landmark measures of two staffs were recognized by the landmark measure recognizer 211. Further, the landmark measures shown in blue are measures that a player has already played and that have been already activated by the activator 214. Thereafter, a measure activated by the activator 214 is the third measure of the five measures shown in green, the music score page turner 215 determines that the landmark measures shown in blue have already been played by the player and can turn the page in a ‘swipe up’ manner so that they are not displayed on the display. Then, the next staff of the music score can be displayed on the display 110. Meanwhile, the turning method is not limited to the ‘swipe up’, and may be implemented in various manners such as ‘swipe sideways’ and ‘page swipe’. The position of the measure where a music score is to be transitioned by the music score page turner 215 may depend on the settings of the music score page turner 215. That is, it is the most preferable to not be limited to a specific turning manner or the position of a specific measure.

Next, when it is required to activate multiple measures among the landmark measures, the activator 214 is characterized by activating one primary measure among the landmark measures. Further, since measures that have been already activated are, as described above, stored in the database 220 and excluded from the similarity selection targets of the similarity calculator 214, there is a remarkable effect that it is possible to track playing of a player sequentially without repeatedly activated measures and easily understand the context of the playing.

For example, referring to FIG. 7, when the mobile application is activated in the device 100 and the music score that a player wants to play is initially displayed on the display 110, the landmarks including a measure A, a measure B, a measure C, a measure D, and a measure A′ may be recognized. In this case, the measure A and the measure A′ are measures that are different only in position and have the same or similar notes and note symbols. The activator 214 can simultaneously activate the measure A and the measure A′ in accordance with the play data and can activate first the measure A that is prioritized in the landmark measures.

Most preferably, the activator 214 can infer the playing context on the basis of reinforcement learning using the habit of a player reading and playing a music score in order. This is because when reinforcement learning is used, it is easy to adjust the internal algorithm in comparison to the deep learning technology or the dynamic time warping (DTW) technique and it is easy to understand the causal relationship through a reward function.

other words, the activator 214 can give a higher reward when a measure, which is activated on the basis of play data input from mistakes made by a player, such as pressing a wrong note due to incorrect fingering, repeating notes, or missing notes, or skipping some measures (jump), returning to and playing a previously played measure (backward jump), or repeating the measure, is closer to the playing position intended by the player during training of the reinforcement learning model. Accordingly, there is a remarkable effect that it is possible to easily identify the playing context by understanding the casual relationship. Further, since the reinforcement learning model is operated for similarity, there is a remarkable effect that it is possible to understand a playing context of play of various musical instruments through only one learning process without the need to learn each of various musical instruments.

### Musical Instrument Play Tracking Method

Hereafter, an embodiment of the present disclosure is described in detail with reference to the accompanying drawings. FIG. 8 is a flowchart of a musical instrument play tracking method of the present disclosure.

Referring to FIG. 8, the musical instrument play tracking method of the present disclosure includes a landmark measure recognition step S100, an important information extraction

Step S200, a similarity calculation Step S300, and an activation step S400.

In more detail, in the landmark measure recognition step S100, multiple measures including play data created by a device 100 are recognized as landmark measures in the music score displayed on the display 100 of the device 100 by means of a landmark recognizer 211.

Most preferably, in the present disclosure, these are a series of processes that are performed with a mobile application activated in the device 100 and with the sound or signals of a musical instrument played by a player installed.

The musical instrument may be a musical instrument that produces analog sounds in accordance with the fingering of a player without any electronic device such as a grand piano, an acoustic guitar, etc. Accordingly, the device 100 receives sound through a given microphone 120 and digitalizes the sound through a frequency band conversion technology or an automatic music transcription technology, thereby being able to create the play data. Here, the automatic music transcription technology refers to arranging the notes and the length of notes of analog sounds into a bar format in order of time. That is, in the landmark measure recognition step S100, the play data created from the sound of a musical instrument input to the device 100 can be obtained.

Alternatively, the musical instrument may be an electric musical instrument that outputs pre-stored digital sound sources in accordance with the finger positions of a player such as a digital piano and an electric guitar, and a musical instrument that outputs pre-stored digital sound sources in accordingly with touch input by a player on a virtual graphic having the shapes of a piano, a guitar, a drum, etc. Accordingly, the device 100 can be connected with an instrument in a wired type through a USB terminal and can receive MIDI signals, and the MIDI signals may be the play data. Alternatively, the play data may be formed by processing some of MIDI signals. Here, the MIDI signal is a standardized signaling protocol system that can be exchanged between digital musical instruments and computers or between a digital musical instrument and a digital musical instrument. That is, in the landmark measure recognition step S100, MIDI signals themselves of a musical instrument input to the device or some of the MIDI signals processed after being input to the device 100 can be obtained as play data.

Further, in order to play certain music, a music score written on multiple pages is required. In general, a music score is composed in accordance with a notation method including note symbols, notes, and auxiliary notations showing playing instructions and the amount of music score that can be printed on one page is limited. In the same way, the display 110 can display only a portion of the entire music score, depending on the size of the display 110 and the notation method of the music score. For example, the display 110 can display only two to four staffs of a music score even if the ratio of the displayed score is appropriately adjusted for each player.

In this case, it is the most preferable that it is determined that the play data is in the musical score displayed on the display 110 in the landmark measure recognition step S100. If the play data is not displayed on the display 110, it is the most preferable that the play data is displayed on the display 110 through an input manner to the device 100 such as scrolling and touching by a player. Accordingly, when the play position of a player on the entire music score that the player is playing is tracked, the data processing time and capacity are significantly consumed. The present disclosure can reduce the target for tracking the play position of a player into the landmark measures on the entire music score using the situation in which a player has to look at a musical score to play a musical instrument, and accordingly, has a remarkable effect of being able to reduce the data processing time and capacity.

Further, the landmark measures may include several staffs including multiple measures. Here, the measure refers to the part between vertical lines in a music score and is the smallest unit of music. That is, the landmark measures include multiple measures composed of a measure including the play data and a measure not including the play data are connected forward and backward with respect to the play data in a music score, and multiple measures can be represented as several staffs together on the display 110. According to the embodiment of the present disclosure of FIG. 2, in the landmark measure recognition step S100, up to three staffs from the top staff of a music score displayed on the display 110 can be recognized as the landmark measures. The landmark measures are shown in green with a certain level of transparency on the music score in FIG. 2.

Next, in the important information extraction step S200, important information including the play data and the frequency and length of notes in a certain measure among landmark measures is extracted by an important information extractor 212.

in the important information extraction step S200, the important information of the play data and the important information of the certain measure can be separately extracted and the manners of extracting the important information are the same. Most preferably, in the important information extraction step S200, the play data and a certain measure among the landmark measures each can be converted into a sequence represented by the pitches of notes over time. Further, in the important information extraction step S200, the frequency of notes, the length of notes, the notes, etc. can be converted as the important information from the sequences represented by the pitches of notes over time.

Next, in the similarity calculation step S300, similarity between the important information of the play data and the landmark measures is calculated by a similarity calculator 213. Most preferably, in the similarity calculation step S300, the similarity can be calculated by performing subsequence matching and Dynamic Time Warping (DTW).

First, in the similarity calculation step S300, important information is compared using a subsequence matching technique, whereby the part corresponding to the play data in the landmark measures can be inferred.

Referring to FIG. 3(a), the subsequence matching technique is an algorithm that is useful for finding a part where one certain sequence corresponds to another sequence. It is preferable in the similarity calculation step S300 to use a SPRING algorithm that performs subsequence matching at a very high speed because time complexity is low.

In more detail, referring to FIG. 3(b), a sequence X may include the important information of the play data and a sequence Y may include the important information of the certain measure. In this case, the start point and the end point of each of the sequence X including the important information of the play data and the sequence Y including the important information of the certain measure have been identified. Further, comparison is performed using the subsequence matching technique in the similarity calculation step S300, it is possible to check whether there is the same part in relation to whether the important information of the play data has the same part in the important information of the certain measure, and locate the same part, or being able to check whether there is a similar part in relation to whether there is a similar part, and locate the similar part even though they are not completely the same. As a result, in the sequence Y, the part that is the same as or similar to the sequence X may be referred to as a subsequence Y′.

Next, in the similarity calculation step S300, the Euclidean distance between histograms showing the frequency of notes in the important information of each of the sequence X and the subsequence Y′ derived by the subsequence matching technique is computed, whereby the similarity of the frequency of the notes can be calculated.

For example, when the histogram values for the frequency of notes of the sequence X derived using the subsequence matching technique are [0.1, 0.2, 0.3, 0.2, 0.2] and the histogram values for the frequency of notes of the subsequence Y′ are [0.6, 0.1, 0.1, 0.1, 0.1], 0.57, which is a value obtained by calculating (0.6-0.1)²+(0.1 -0.2)²+(0.1 -0.3)²+(0.1 -0.2)²+(0.1 -0.2)² in accordance with a euclidean distance computation method and then taking the square root, can be derived as the similarity for the frequency of the notes in the similarity calculation step S300. In this case, when the Euclidean distance is 0, it can be determined that the frequencies of notes between the sequence X and the subsequence Y′ are the same, and the closer the Euclidean distance is to 0, the higher the similarity for the frequencies of the notes between the sequence X and the subsequence Y′ can be determined.

However, referring to FIG. 4(a), since the Euclidean distance computation method performs simple comparison on the basis of time, high similarity for perfectly matched play can be calculated, but there is a technical imitation in calculating low similarity for structural play errors or improvisation by a player. The present disclosure aims to overcome the aforementioned technical limitations of the Euclidean distance computation method and to allow a corresponding part of a music score to be properly activated by flexibly handling structural play errors and improvisation by a player.

Next, in the similarity calculation step S300, the similarity of the lengths of notes between the sequence X and the subsequence Y′ derived by the subsequence matching technique can be calculated using the dynamic time warping (DTW) technique.

Referring to FIG. 4(b), the dynamic time warping (DTW) method does not simply compare two sequences and performs time-warping that randomly elongates or reduces a portion of a sequence, thereby being able to find an optimal path that makes two sequences appear as similar as possible. In this case, the dynamic time warping (DTW) has to calculate all computations on a Cost-Matrix to find an optimal path, so it becomes slower as the lengths of two sequences increase. Accordingly, the similarity calculation step S300 has only to find an optimal path by performing only operations on a Cost-Matrix that corresponds to the sequence X and the subsequence Y′, so the amount of operations is low, whereby the similarity of the lengths of notes can be calculated at a high operation speed.

Accordingly, in the embodiment of FIG. 5, in the similarity calculation step S300, the similarity of the frequencies of notes can be calculated as 0.09 through a Euclidean distance measurement method and the similarity of the lengths of the notes can be calculated as 0.05 through dynamic time warping (DTW). Further, in the similarity calculation step S300, 0.14 that is the sum of the two calculated similarities can be derived as the final similarity. In this case, the smaller the similarity value, the more similar they can be determined to be.

Accordingly, the current play position of a player can be recognized only when the player start playing from the very beginning of a music score in the related art. However, according to the present disclosure, since the similarity of all of the measures in a music score displayed on the display 110, that is, the landmark measures is calculated, even though a player plays any measured in the music score displayed on the display 110 without playing in advance from the very beginning of the music score or the measure two to three measures earlier from the measure that the player wants to play, it is possible to track the current position, whereby there is an effect that the convenience for play of a player is improved.

Next, in the activation step S400, the certain measure is activated on the display 110 in accordance with the similarity so that the play position can be visually easily located.

Most preferably, in the activation step S400, a similarity reference value obtained from a pre-trained Support Vector Machine (SVM) model and the final similarity are compared, and it can be determined that the play data corresponds to a certain measure among landmark measures when the final similarity is the reference value or lower.

Meanwhile, the SVM model can be trained with positive data determined to be measures played by an unspecified majority and negative data determined to be measures not played.

For example, when the reference value obtained from the SVM model is 0.33 and the final similarity is 0.14, 0.14 that is the final similarity is smaller than the reference value, so, in the activation step S400, it can be determined that a sequence X that is the play data is similar to a sequence Y′ that is a certain measure among the landmark measures and it can be determined that the player played the certain measure among the landmark measures. Further, in the activation step, a corresponding measure or note can be activated on the display 110.

On the contrary, when the reference value obtained from the SVM model is 0.33 and the final similarity is 0.36, 0.36 that is the final similarity is larger than 0.33 that is the reference value, so, in the activation step S400, it can be determined that a sequence X that is the play data would not be similar to a sequence Y′ that is a certain measure among the landmark measures and the corresponding note or measure may not be activated on the display 100.

Referring to FIG. 2 again, it can be seen that a note and measures activated through the activation step S400 are shown in dark green in the landmark measures. Accordingly, the present disclosure performs calculation of similarity for measures that are basic units generally for a player to recognize a music sore and performs activation on a measure-by-measure basis, whereby the current play position is not activated only on a note-wise base, as in the related art, and can be activated on a measure-wise base. Accordingly, compared to being activated only on a note-wise basis on the display 110, screen changes are significantly reduced, so there is an effect of allowing the current play position to be intuitively and accurately recognized without confusing a player. Further, even if the speed of activation based on measures is slightly low or high in comparison to note-wise activation on the display 110, there is an effect of not greatly confusing a player.

Further, a player can visually check his/her current play position on a music score displayed on the display and the pages of the music score can be automatically turned solely through playing without making any gestures during playing, so there is an effect that the player can concentrate more on playing.

Meanwhile, the musical instrument play tracking method of the present disclosure may further include a storing step in which a certain measure activated through the activation step S400 and at least one of notes included in the certain measure also activated by the activator 214 are stored by a database 220 (S500). Further, the similarity calculation step S300 is characterized by excluding the certain measure and at least one of the notes included in the certain measure stored through the storing step S500 from the selection targets to prevent them from being repeatedly activated in the activation step S400.

In other words, in the present disclosure, the landmark measure recognition step S100, the important information extraction step S200, the similarity calculation step S300, and the activation step S400 described above can be repeated such that the notes and the measures that a player is currently playing are continuously activated. The repeat interval may be different, depending on the interval set in advance in at least one processor 210. For example, when 0.4 seconds is set as a repeat time, all of the processes can be repeated sequentially in order of 0 seconds, 0.4 seconds, 0.8 seconds, . . . from the landmark measure recognition step S100 as a lead that is the first step, and as a result, multiple notes and measures can be activated through the activation step S400. For example, in the activation step S400, a note A and a note B can be activated in the landmark measures at 0 seconds and 0.4 seconds, respectively. Further, in the similarity calculation step S300, the pre-stored note A and the note B can be checked from the database 220 at 0.8 seconds, and then they are excluded from the similarity selection targets and similarity can be calculated for the similarity selection targets excluding the note A and the note B. That is, in the similarity calculation step S300, the important information of the note A and the note B can be excluded when the similarity is calculated. If the note A and the note B form a certain measure together, multiple notes activated on a measure-by-measure basis can be stored in the storing step S500.

Accordingly, the present disclosure can prevent notes and measures, which a player has already played, can improve accuracy, and can reduce the targets that need to be computed in the similarity calculation step S300, so there is a remarkable effect of being able to increase the computation speed and decrease the computational load.

Next, the musical instrument play tracking method of the present disclosure may further include a music score page turning step that turns pages of a music score that are displayed on the display 110 by means of a music score page turner 215 in accordance with the positions of notes activated in the activation step S400 in the landmark measures to improve convenience for a player.

As described above, a music score page displayed on the display 110 may be a portion of the entire music score of music. According to an embodiment of the present disclosure, since two to four staffs of the music score are displayed on the display 110, a situation occurs where a player needs to turn the pages of the music score while playing. The music score page turning step S600 of the present disclosure aims to automatically turn the pages of a music score so that playing is not interrupted in the situation where a player needs to turn a page of the music score while playing.

Referring to FIG. 6, landmark measures are shown in blue and green on a certain music score. That is, landmark measures of two staffs were recognized in the landmark measure recognition step S100. Further, the landmark measures shown in blue are measures that a player has already played and that have been already activated in the activation step S400. In this case, a measure activated in the activation step S400 is the third measure of the five measures shown in green, in the music score page turning step S600, it is determined that the landmark measures shown in blue have already been played by the player and the page can be turned in a ‘swipe up’ manner so that they are not displayed on the display. Then, the next staff of the music score can be displayed on the display 110. Meanwhile, the music score page turning step S600 can turn a page of a music score not only through the ‘swipe up’ manner, but various manners such as ‘swipe sideways’ and ‘page swipe’. The position of the measure where a music score is to be transitioned through the music score page turning step S600 may depend on the settings of the music score page turner 215 That is, it is the most preferable to not be limited to a specific turning manner or the position of a specific note.

Next, when it is required to activate multiple measures among the landmark measures, the activation step S400 is characterized in that one primary measure among the landmark measures is activated. Further, since measures that have been already activated are, as described above, stored in the database 220 in the storing step S500 and excluded from the similarity selection targets of the similarity calculation step S300 that is repeated, there is a remarkable effect that it is possible to track playing of a player sequentially without repeatedly activated measures and easily understand the context of the playing.

For example, referring to FIG. 7, when the mobile application is activated in the device 100 and the music score that a player wants to play is initially displayed on the display 110, the landmarks including a measure A, a measure B, a measure C, a measure D, and a measure A′ may be recognized. In this case, the measure A and the measure A′ are measures that are different only in position and have the same or similar notes and note symbols. In the activation step S400, the measure A and the measure A′ can be simultaneously activated in accordance with the play data and the measure A that is prioritized in the landmark measures can be activated first.

Most preferably, in the activation step S400, the playing context can be inferred on the basis of reinforcement learning using the habit of a player reading and playing a music score in order. This is because when reinforcement learning is used, the internal algorithm is easy to adjust in comparison to the deep learning technology or the dynamic time warping (DTW) technique and the causal relationship is easily understood through a reward function.

In other words, the activation step S400 can give a higher reward when a measure, which is activated on the basis of play data input from mistakes made by a player, such as pressing a wrong note due to incorrect fingering, repeating notes, or missing notes, or skipping some measures (jump), returning to and playing a previously played measure (backward jump), or repeating the measure, is closer to the playing position intended by the player during training of the reinforcement learning model. Accordingly, there is a remarkable effect that it is possible to easily identify the playing context by understanding the casual relationship. Further, since the reinforcement learning model is operated for similarity, there is a remarkable effect that it is possible to understand a playing context of play of various musical instruments through only one learning process without the need to learn each of various musical instruments.

There is a technology of turning the pages of a musical score on the basis of gestures of a player using a sensor such as a pedal or a camera in the related art, but this is a technology having a technical limitation in application to playing of instrument with separate pedals such as a piano and it is required to pay attention to the timing in order to turn the pages of a music score during complex playing when playing a music instrument, so there is the inconvenience of not being able to fully concentrate on playing of the musical instrument. Further, there is a technology of automatically turning the pages of a music score at predetermined intervals or automatically turning a page of a musical score when a specific note is accurately played, but this cannot deal with errors or improvisation of a player, so there is technical limitation in terms of practicality.

As described above, according to the present disclosure, there is a remarkable effect that it is possible to accurately track a play position of the current playing on a music score and automatically turn the pages of the music score by calculating the similarity between the current playing and the music score. Further, there is a remarkable effect that even though automatic turning is not performed due to low similarity between the play data of a player and a certain measure, it is possible to easily find out which measure was not correctly played, depending on whether the measure is activated. Further, since similarity is not calculated for the entire music score and is calculated within landmark measures, it is possible to reduce unnecessary computation and can quickly respond to real-time playing. Further, there is a remarkable effect that even though a player makes mistakes in playing or improvises, it is possible to accurately track a play position on a music score by quickly and robustly responding to them.

Embodiments can be implemented by hardware, software, firmware, middle ware, micro codes, hardware description languages, or a certain combination thereof. When the embodiments are implemented by software, firmware, middle ware, or micro codes, program codes or code segments that perform necessary work can be stored in a computer-readable recording medium and can be executed by one or more processors.

Further, the aspects of the subject maters described in the specification can be explained in the general context of computer-readable commands such as program modules or components that are executed by a computer. In general, program modules or components include a routine, a program, an object, and a data structure that perform specific work or implement a specific data format. The aspects of the subject matters explained in the specification may be executed in distributed computing environments in which work is performed by remote processing devices linked through a communication network. In the distributed computing environments, program modules may be positioned in both of local and remote computer storage media including memory storage devices.

Embodiments were described above with reference to the limited examples and drawings, but they may be changed and modified in various ways by those skilled in the art. For example, the described technologies may be performed in order different from the described method, and/or even if components such as the described system, structure, device, and circuit are combined or associated in different ways from the description or replaced by other components or equivalents, appropriate results can be accomplished.

Therefore, other implements, other embodiments, and equivalents to the claims are included in the following claims.

1. A musical instrument play tracking system comprising:
a device displaying a music score of music, which a player wants to play with a musical instrument, on a display and creating play data for musical instrument play of the player; and
an application server including at least one processor, which tracks a play position on the music score on the basis of the play data, and operating a mobile application that support a musical instrument play platform, wherein the at least one processor includes:
a landmark measure recognizer recognizing multiple measures in a predetermined number of staffs from a top staff in the musical score displayed on the display as landmark measures;
an important information extractor extracting important information including the play data and the frequency and length of notes in a certain measure among the landmark measures;
a similarity calculator calculating similarity between the important information of the play data and the important information of the certain measure among the landmark measures; and
an activator activating the certain measure on the display in accordance with the similarity such that the play position is easily and visually located.

2. The musical instrument play tracking system of claim 1, wherein the application server further includes a database storing the certain measure activated by the activator and at least one of the notes included in the certain measure, and
the similarity calculator excludes the certain measure and at least one of the notes included in the certain measure stored in the database from selection targets to prevent the certain measure and the at least one note from being repeatedly activated by the activator.

3. The musical instrument play tracking system of claim 1, wherein an music score page turner turning pages of a music score that are displayed on the display in accordance with positions of measures activated by the activator in the landmark measures to improve convenience for a player.

4. The musical instrument play tracking system of claim 1, wherein when it is required to activate multiple measures among the landmark measures, the activator activates one primary measure among the landmark measures.

5. A musical instrument play tracking method comprising:
a landmark measure recognition step in which multiple measures in a predetermined number of staffs from a top staff in a musical score displayed on a display of a device are recognized as landmark measures by means of a landmark measure recognizer;
an important information extraction step in which important information including play data created by the device and the frequency and length of notes in a certain measure among the landmark measures is extracted by an important information extractor;
a similarity calculation step in which similarity between the important information of the play data and the landmark measures is calculated by a similarity calculator; and
an activation step in which the certain measure is activated on the display in accordance with the similarity such that a play position is easily and visually located.
